(19) United States
(12) Patent Application Publication
(10) Pub. No.: US 2002/0115433 A1
(43) Pub. Date: Aug. 22, 2002

(54) Ice-making machinery and a tool and method for control thereof

(75) Inventor: Melvin Anthony Baker, Grayslake, IL (US)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: Scotsman Ice Systems

(21) Appl. No.: 10/071,845

(22) Filed: Feb. 8, 2002

Related U.S. Application Data
(60) Provisional application No. 60/268,619, filed on Feb. 9, 2001.

(51) Int. Cl. H04M 3/00

(52) U.S. Cl. 455/420; 455/418

(57) ABSTRACT

An ice-making machine having a controller that can be controlled by a programmable tool via a wireless communication for manufacturing and/or field service processes. The controller and tool are programmed to communicate with one another to perform downloads of data or software, uploads of data and diagnostic procedures. The tool can be programmed to communicate with different types of controllers so that a single tool can be used to service all of the controllers.

This Application claims the benefit of U.S. Provisional Application No. 60/268,619, filed on Feb. 9, 2001.

### FIELD OF THE INVENTION

This invention relates to ice-making machinery and to a tool and method for controlling various operations thereof.

### BACKGROUND OF THE INVENTION

Ice-making machines are used to make ice in various forms, such as ice cubes, flakes and the like. Ice-making machines generally include an evaporator, a refrigerant supply, a water supply, a controller and an ice bin. Ice-making machines that make cubes have a freeze cycle and a subsequent harvest cycle. During the freeze cycle, the evaporator is cooled by liquid refrigerant provided by the refrigerant supply so as to form ice cubes from water provided by the water supply. During the harvest cycle, the evaporator is warmed by hot gas that is provided by the refrigerant supply to free the ice cubes, which then fall into the ice bin. During the freeze cycle and the harvest cycle, the controller controls the refrigerant supply and the water supply. Ice-making machines that make flakes operate continuously to form ice on a surface of the evaporator, which is mechanically removed by an augur. For either cube or flake ice-making machines, the controller also controls other operations such as, cleaning or rinsing of all surfaces that contact water or ice.

Generally, the controller is serviced in the field by a service person with a special purpose tool. The tool is connected by a wire or cable to the controller. When connected, the tool can be used to perform diagnostics. The tool is a special purpose one, as its capabilities are limited to diagnostics and to a specific controller. This results in high costs since different controllers require different tools and service personnel must learn how to use each tool.

There is a need for an ice-making machine, a tool and a method that has a wide range of functional capability to control various operations thereof for manufacturing, field service, refurbishment and other purposes.

There is also a need for a tool and that is capable of servicing a variety of different controllers.

### SUMMARY OF THE INVENTION

The method of the present invention satisfies the aforementioned needs by performing manufacturing or field service operations on a controller of an ice-making machine with a general purpose portable tool. An operator uses the portable tool to send a wireless communication to the controller to initiate a session. The operator then issues one or more messages via the tool to the controller. These messages may request the performance of a diagnostic procedure, an upload of operating data, a download of operating parameters, a download of software or for other operations. The tool may be programmed with operating parameters, software corrections and/or diagnostic procedures for a number of different types of controllers so that the same tool can be used to service all of the types of controllers. This eliminates a need for separate tools for different types of controllers.

The ice-making machine of the present invention includes a water supply, a refrigerant supply and an evaporator, and a controller. The controller has a transceiver capable of sending and receiving wireless communications. If the ice-making machine makes cubes, the controller has means for controlling the water supply, the refrigerant supply and the evaporator to form ice during a freeze cycle and to harvest ice during a harvest cycle. If the ice-making machine makes flakes, the controller has means for controlling the water supply, the refrigerant supply and an augur. For either a cube or a flake machine, the controller also includes means for conducting a manufacturing and/or a field service operation in accordance with one or more of the above-described requests received via the transceiver from an external tool.

According to another aspect of the method of the present invention, a message is sent to the controller from a portable programmable unit via a wireless link. A style and a content of the message are controlled. The content may be a diagnostic procedure, an upload of operating data and/or parameters, a download of operating data and/or parameters, a download of software and a change in operating mode or other type of operating data or control data.

According to one feature of this aspect of the method, the controller is a first type of a plurality of different types of controllers, and the style of the message is controlled to correspond to the first type of controller. According to another feature, the type of the controller is identified and the style of the message is controlled to correspond to the identified type of controller.

Another feature of this aspect of the method of the present invention causes a first message to be sent to the controller that causes the controller to send a reply message that identifies its type.

The portable programmable unit or tool of the present invention has a processor, a memory and a transceiver capable of sending and receiving wireless communications. The tool is capable of sending a wireless communication via the transceiver to the controller to initiate a session for manufacturing and/or field service operations. The other aspect of the method of the invention is performed by the tool. For example, the tool may be programmed with the operating parameters, software corrections and/or diagnostic procedures for a number of different types of controllers so that the same tool can be used to service all of the types of controllers. This eliminates a need for separate tools for different types of controllers.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a block diagram of an ice-making machine of the present invention;

FIG. 2 is a block diagram of a controller of the FIG. 1 ice-making machine;

FIG. 3 is a flow diagram of procedures for the portable tool of the FIG. 1 ice-making machine; and

FIG. 4 is a flow diagram of procedures for the controller of FIG. 2.

### DESCRIPTION OF THE PREFERRED EMBODIMENT

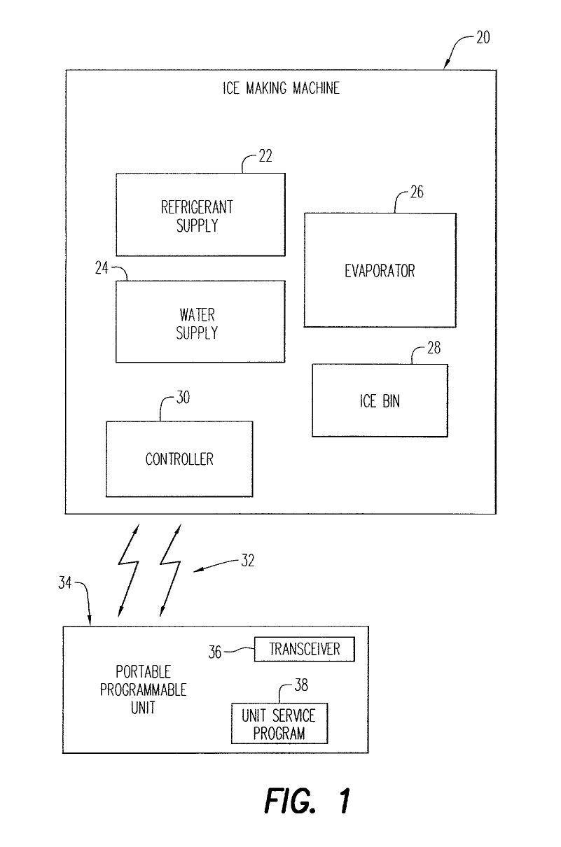

Referring to FIG. 1, an ice-making machine 20 includes a refrigerant supply 22, a water supply 24, an evaporator 26, an ice bin 28 and a controller 30. If ice-making machine 20 makes cubes, controller 30, during a freeze cycle, controls refrigerant supply 22 to provide liquefied refrigerant to cool evaporator 26 and further controls water supply 24 to supply water to the cooled evaporator so as to form ice on a surface thereof. During a subsequent harvest cycle, controller 30 controls refrigerant supply 22 to provide warm gasified refrigerant to evaporator 26 to free the ice cubes, which fall into ice bin 28. If ice-making machine 20 makes flakes, controller 30 controls refrigerant supply 22, water supply 24 and an augur.

Controller 30 is also arranged to communicate via a wireless link 32 with a portable programmable unit 34. Wireless link 32 may be any wireless technology that is capable of wireless transmission in the frequency spectrum. For example, wireless link 32 may operate in the infrared portion, the radio frequency portion, the microwave portion, the visible portion or other portion of the frequency spectrum. Portable programmable unit 32 may be any suitable portable general purpose computer device, known currently or in the future, that has a wireless communication capability, such as a laptop computer, a hand held computing device and the like. Preferably, portable programmable unit 32 is a hand held computing device that is easily carried from one location to another by manufacturing or field personnel for performing various operations with controller 30, such as downloading software, operating data and/or parameters, and the like, uploading operating data and/or parameters, operating data and the like, controlling the performance of diagnostics and other operations. For example, suitable hand held portable programmable units are commercially available from Palm Corporation, Hewlett Packard Corporation, Sony Corporation, Cassio Corporation, Compaq Corporation, and other vendors..

Portable programming unit 34 includes a transceiver 36 and a unit service program 38. Transceiver 36 is capable of sending and receiving messages in a selected portion of the frequency spectrum, for example, the infrared portion. Unit service program 38 causes portable programmable unit 38 to operate as a tool for a work person to conduct a session with controller 30 for the performance of the various operations required in the manufacture or field service of ice-making machine 20.

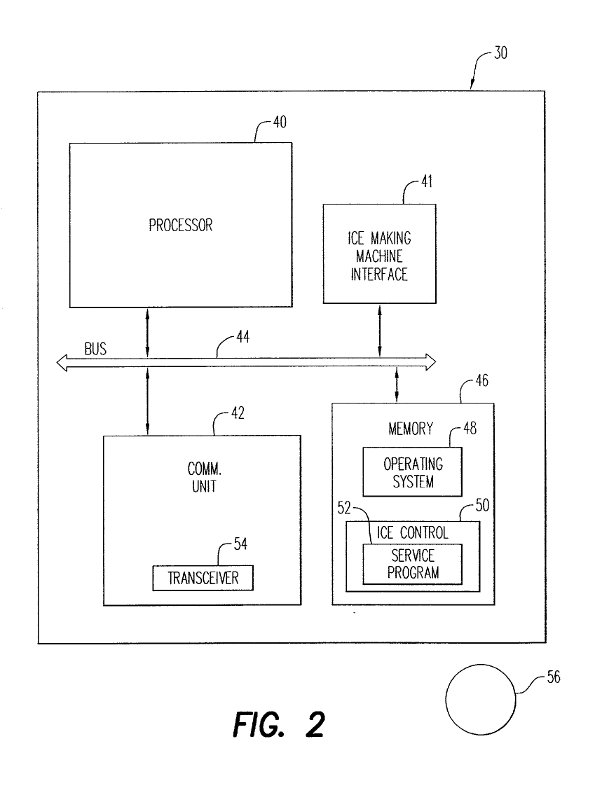

Referring to FIG. 2, controller 30 includes a processor 40, an ice making machine interface 41, a communications unit 42 and a memory 46 that are interconnected via a bus 44. Memory 46 includes an operating system 48 and an ice control program 50 that includes a service program 52 of the present invention. Other programs, such as utilities and other applications, may also be stored in memory 46. All of these programs may be loaded into memory 46 from a storage medium, such as a disk 56 via a direct connection or via portable programmable unit 34. Communications unit 42 includes a transceiver 54 that is capable of sending and receiving messages in a selected portion of the frequency spectrum, for example, the infrared portion.

Processor 40 is operable under the control of operating system 48 to execute ice control program 50 to control the freeze, harvest and other cycles of ice-making machine 20 as well as the operations of service program 52.

Portable programming unit 34 is used by an operator to cause various operations to be performed by controller 30. For example, portable programming unit 34 can control a download of software or data from unit 34 to controller 30, an upload of data from controller 30 to unit 34, performance of a diagnostic procedure, and the like. These operations may be performed at the time of manufacture by a manufacturing technician or in the field by field personnel or by a technician at the time of a refurbishment.

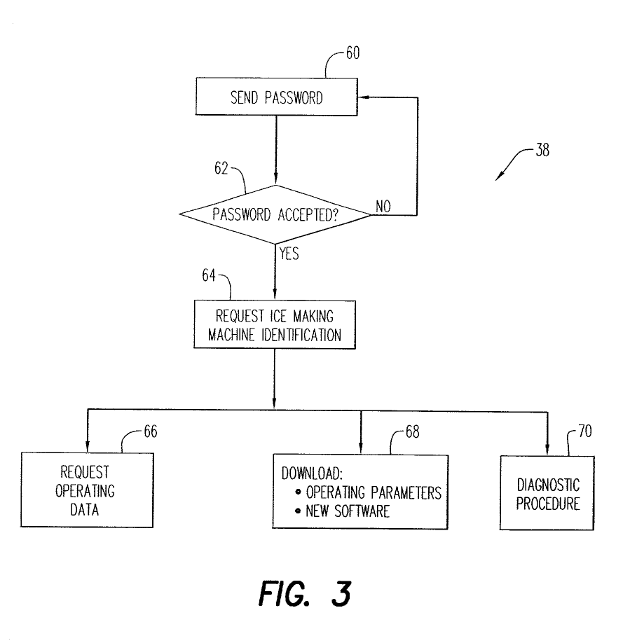

Referring to FIG. 3, unit service program 38 has an initial step 60 in which a password, which may have been entered by an operator, is sent to controller 30. At step 62, it is determined if controller 30 has accepted the password. If not, control is returned to step 60 to prompt the operator to enter a valid password. If step 62 determines that the password has been accepted, step 64 sends a request to controller 30 to provide its identification, for example, model number and serial number. Thereafter, unit service program 38 can perform one or more operations via a series of messages that are controlled as to style and content. The style is controlled to correspond to the identified type of controller. For example, the program style and data parameters of each style required for the entire family of controller types may be stored in portable programming unit 34. On the other hand, portable programming unit 34 can respond to the identified controller type to communicate with a remote computer via a network to obtain the program style and data style needed for the identified controller type.

The content is also controlled. Thus, at step 66, service program 38 may request an upload of operating data, such as run time, operating parameters, discharge temperature, last operating mode, cycle time, failure code or other information. At step 68, service program 38 may initiate a download of software or of operating parameters. At step 70, service program 38 may institute a diagnostic procedure for ice-making machine 20. The diagnostic procedure may be stored in memory 46 of controller 30, in portable programming unit 34 or distributed between memory 46 and portable programming unit 34. In either case, the results of the procedure are transferred from controller 30 to portable programming unit 34 via wireless link 32. These results can then be transferred to a computer for processing and/or retention in a database.

The information obtained by step 64 allows unit service program 38 to determine the type of controller 30 and to determine the appropriate data, software and diagnostic procedure for that type of controller 30. For example, the operating parameters, software corrections, and diagnostic procedures for a variety of different types of controllers may be stored in portable programming unit 34. This is especially useful for field service operations, so that a common general purpose tool can be used to service many different types of controllers installed in the field.

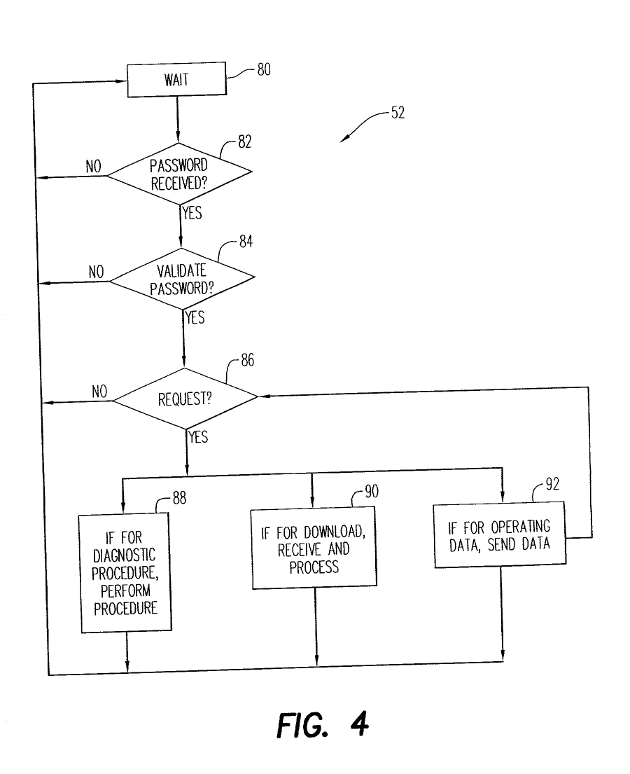

Referring to FIG. 4, service program 52 idles at a wait step 80 until a password is received as determined by step 82. If step 82 determines that no password has been received, control returns to step 80. If a password has been received, step 84 performs a validation procedure. If the password is invalid, control is returned to step 80 and notice that the password is not accepted is sent to portable programmable unit 34. If the password is valid, notice of acceptance of the password is sent to portable programmable unit 34. Step 86 then determines if a request has been received. If not, control returns to step 80. If yes, control passes steps 88, 90 or 92 depending on the type of request. If the request is for the performance of a diagnostic procedure, step 88 performs the procedure and returns any diagnostic result data to portable programmable unit 34, as required. If the request is for a download, step 90 processes the request. For example, if the download is a set of operating parameters, the downloaded operating parameters are loaded into appropriate buffers. If the download is a software correction, the downloaded software is loaded into memory 46 to supplement or replace existing software. If the request is for operating data, step 92 sends the operating data to portable programming unit 34 via wireless link 32. When step 88, 90 or 92 has been completed control is returned to step 80.

The present invention also contemplates that the access of a field service technician would be restricted to diagnostic procedures and permitted field service changes. On the other hand, access of a manufacturing technician would be much broader. Thus, step 84 of FIG. 4 further determines an access level for the password. The access level then determines the extent of access and ability to make changes for steps 66, 68 and 70 (FIG. 3) and steps 88, 90 and 92 (FIG. 4).

The present invention having been thus described with particular reference to the preferred forms thereof, it will be obvious that various changes and modifications may be made therein without departing from the spirit and scope of the present invention as defined in the appended claims.

What is claimed is:

1. A method for performing various operations on a controller of an ice-making machine, comprising:
(a) sending a wireless communication to said controller from a portable programmable unit to initiate a session; and
(b) issuing one or more requests from said portable programmable unit to said controller, wherein said one or more requests are selected from the group that consists of: a diagnostic procedure, an upload of operating data and/or parameters, a download of operating data and/or parameters, a download of software and a change in operating mode.

2. An ice-making machine comprising:
a water supply, a refrigerant supply and an evaporator,
a controller including
a transceiver capable of sending and receiving wireless communications;
first means for controlling said water supply, said refrigerant supply and said evaporator to form ice during a freeze cycle and to harvest ice during a harvest cycle;
second means for conducting an operation in accordance with one or more requests received via said transceiver from an external unit, wherein said one or more requests are selected from the group that consists of: a diagnostic procedure, an upload of
operating data and/or parameters, a download of operating data and/or parameters, a download of software and a change in operating mode.

3. A method for communicating with a controller of a food service equipment ice-making machine, comprising:
(a) sending a message to said controller from a portable programmable unit via a wireless link; and
(b) controlling a style and a content of said message.

4. The method of claim 3, wherein said content is selected from the group that consists of: a diagnostic procedure, an upload of operating data and/or parameters, a download of operating data and/or parameters, a download of software and a change in operating mode.

5. The method of claim 4, wherein said controller is a first type of a plurality of different types of controllers, and wherein step (b) controls said style to correspond to said first type of controller.

6. The method of claim 5, further comprising the step of identifying said first type, and wherein step (b) responds to said identified first type to control said style to correspond thereto.

7. The method of claim 6, wherein said identifying step causes step (a) to send a first message to said controller that causes said controller to send a reply message that identifies said first type.

8. A portable programmable unit having a processor and a memory, comprising:
a transceiver capable of sending and receiving wireless communications;
first means for sending a message from said transceiver to a controller via a wireless link; and
second means controlling a style and a content of said message.

9. The portable programming unit of claim 8, wherein said content is selected from the group that consists of: a diagnostic procedure, an upload of operating data and/or parameters, a download of operating data and/or parameters, a download of software and a change in operating mode.

10. The portable programming unit of claim 8, wherein said controller is a first type of a plurality of different types of controllers, and wherein said second means controls said style to correspond to said first type of controller.

11. The portable programming unit of claim 10, wherein said second means identifies said first type and controls said style to correspond to said identified first type.

12. The portable programming unit of claim 11, wherein said second means causes said first means to send a first message to said controller that causes said controller to send a reply message that identifies said first type.
